(19) United States
(12) Patent Application Publication
(10) Pub. No.: US 2021/0184225 A1
(43) Pub. Date: Jun. 17, 2021

(54) METHOD OF MANUFACTURING FUEL CELL CATALYST LAYER

(71) Applicant: TOYOTA JIDOSHA KABUSHIKI KAISHA, Toyota-shi (JP)

(72) Inventors: Kazuomi YAMANISHI, Toyota-shi (JP); Joji YOSHIMURA, Toyota-shi (JP)

(73) Assignee: TOYOTA JIDOSHA KABUSHIKI KAISHA, Toyota-shi (JP)

(21) Appl. No.: 16/952,625

(22) Filed: Nov. 19, 2020

(30) Foreign Application Priority Data
Dec. 17, 2019 (JP) 2019-227084

(51) Int. Cl. H01M 4/88; H01M 4/90; F26B 5/02

(52) U.S. Cl. CPC H01M 4/8878; F26B 5/02; H01M 4/8828; H01M 4/9008

(57) ABSTRACT

A method of manufacturing a fuel cell catalyst layer includes: coating a top surface of a sheet with a catalyst ink, wherein the catalyst ink includes an ionomer; and drying the catalyst ink on the sheet being conveyed along a conveying direction by spraying a center of an ultrasonic airflow toward a direction opposite to the conveying direction, wherein the ultrasonic airflow is obtained by applying ultrasonic waves to an airflow.

### CROSS REFERENCE TO RELATED APPLICATIONS

This application claims priority based on Japanese Patent Application No. 2019-227084 filed on Dec. 17, 2019, the entire disclosure of which is hereby incorporated by reference.

### BACKGROUND

### Field

The present disclosure relates to a method of manufacturing a fuel cell catalyst layer.

### Related Art

In a method of manufacturing a fuel cell catalyst layer, a technology is disclosed where a catalyst ink with which the top of a base material for transfer is coated is dried (for example, Japanese Unexamined Patent Application Publication No. 2015-201254). In the drying of the catalyst ink, hot air or infrared rays may be used.

There is a problem in which a catalyst ink before being dried flows on a base material by the wind pressure of hot air and in which thus variations in the dimensions of the coating range of the catalyst ink are produced. Such a problem is particularly remarkable when the wind pressure of the hot air is increased in order to enhance the productivity of a drying step.

### SUMMARY

According to one aspect of the present disclosure, a method of manufacturing a fuel cell catalyst layer is provided. The method of manufacturing a fuel cell catalyst layer includes: coating a top surface of a sheet with a catalyst ink, wherein the catalyst ink includes an ionomer; and drying the catalyst ink on the sheet being conveyed along a conveying direction by spraying a center of an ultrasonic airflow toward a direction opposite to the conveying direction, wherein the ultrasonic airflow is obtained by applying ultrasonic waves to an airflow. In the method of manufacturing a fuel cell catalyst layer according to this aspect, the ultrasonic airflow in which the center is directed in the direction opposite to the conveying direction is sprayed to the catalyst ink being conveyed along the conveying direction, and thus the catalyst ink is dried. It is possible to spray the ultrasonic airflow from one position toward the catalyst ink in a wide range on the upstream side. Hence, it is possible to spray, toward the catalyst ink on the upstream side, the ultrasonic airflow which has such a low wind pressure that the catalyst ink is prevented from being sprayed out on the surface of the layer, with the result that it is possible to facilitate the drying of the catalyst ink on the upstream side. Thus, it is possible to reduce a failure in which the catalyst ink after the coating is sprayed out by the ultrasonic airflow, thereby exceeding a coating range on the sheet.

### BRIEF DESCRIPTION OF THE DRAWINGS

FIG. 1 is a cross-sectional view schematically showing a fuel cell which includes an electrode catalyst layer;

FIG. 2 is an illustrative view schematically showing the configuration of a catalyst layer manufacturing apparatus;

FIG. 3 is a manufacturing process diagram showing a method of manufacturing the electrode catalyst layer in the present embodiment;

FIG. 4 is an illustrative view showing a relationship between an ultrasonic airflow fed out from an upstream side ultrasonic nozzle row and the wind pressure of the ultrasonic airflow applied to a catalyst ink; and

FIG. 5 is a graph showing the distribution of concentration of an ionomer in the direction of thickness of the electrode catalyst layer.

### DETAILED DESCRIPTION

### A. First Embodiment

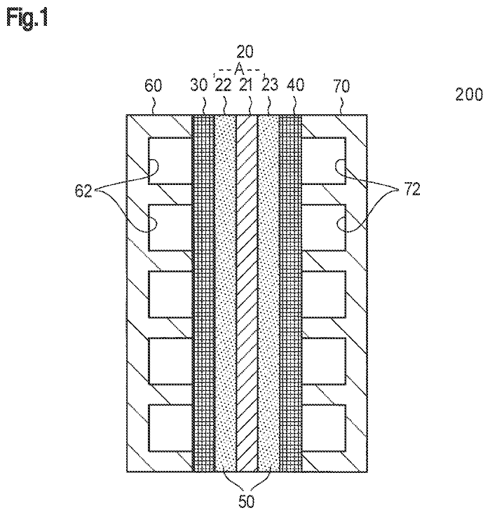

FIG. 1 is a cross-sectional view schematically showing a fuel cell 200 which includes an electrode catalyst layer 50 that is manufactured by a method of manufacturing a fuel cell catalyst layer in a first embodiment of the present disclosure. The fuel cell 200 is a solid polymer fuel cell to which hydrogen gas serving as a fuel gas and air serving as an oxidizing gas are supplied as reaction gases, and which thereby generates power. A membrane electrode assembly (MEA) 20 is sandwiched between a cathode-side separator 60 including an oxidizing gas flow path 62 and an anode-side separator 70 including a fuel gas flow path 72 so as to form the fuel cell 200. Although the one fuel cell 200 is shown in FIG. 1, a plurality of fuel cells 200 may be stacked in layers according to an output voltage which is required.

The membrane electrode assembly 20 functions as the electrode membrane of the fuel cell 200. The membrane electrode assembly 20 includes: a flat plate-shaped electrolyte membrane 21; a cathode-side electrode catalyst layer 22 which is arranged on a surface corresponding to the cathode of the electrolyte membrane 21; and an anode-side electrode catalyst layer 23 which is arranged on a surface corresponding to the anode of the electrolyte membrane 21. The electrolyte membrane 21 is a proton conductive ion exchange resin membrane which is formed of an ionomer. As the electrolyte membrane 21, for example, a fluorine resin such as Nafion (registered trademark) is used. In the following description, when the cathode-side electrode catalyst layer 22 and the anode-side electrode catalyst layer 23 are not distinguished from each other, they are also referred to as the “electrode catalyst layer 50”.

Gas diffusion layers 30 and 40 are conductive members which have gas diffusivity. As the gas diffusion layers 30 and 40, for example, carbon cloth, carbon paper or the like is used which is formed of non-woven fabric. The cathode-side gas diffusion layer 30 is arranged on the outer surface of the cathode-side electrode catalyst layer 22, and the anode-side gas diffusion layer 40 is arranged on the outer surface of the anode-side electrode catalyst layer 23. The membrane electrode assembly 20 including the gas diffusion layers 30 and 40 is also referred to as the “membrane electrode and gas diffusion layer assembly (MEGA)”.

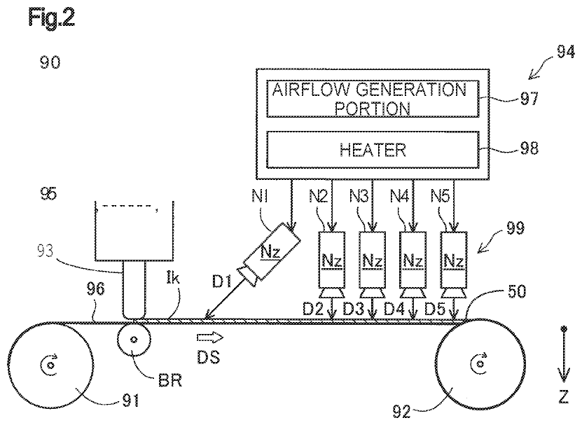

FIG. 2 is an illustrative view schematically showing the configuration of a catalyst layer manufacturing apparatus 90. The catalyst layer manufacturing apparatus 90 is an example of the apparatus which performs the method of manufacturing the electrode catalyst layer 50 in the present embodiment. In FIG. 2, a Z direction is shown which is parallel to the direction of gravity. The catalyst layer manufacturing apparatus 90 coats the surface of a sheet-shaped base material 96 with a catalyst ink and dries the catalyst ink so as to form the electrode catalyst layer 50. The catalyst layer manufacturing apparatus 90 includes: a feed-out roll 91 on which the sheet-shaped base material 96 is wound; a winding roll 92; a coater 95; and an ultrasonic dryer 94. Instead of the base material 96, the sheet-shaped electrolyte membrane 21 may be used.

The feed-out roll 91 and the winding roll 92 each are rotated with unillustrated motors. The base material 96 is fed out by the rotation of the feed-out roll 91, is conveyed along a conveying direction DS in a state where a tension is provided, and is wound on the winding roll 92. With respect to one reference position of the catalyst layer manufacturing apparatus 90, a side opposite to the conveying direction DS, that is, the side of the feed-out roll 91 is also referred to as the “upstream side”, and the side of the conveying direction DS, that is, the side of the winding roll 92 is also referred to as the “downstream side”.

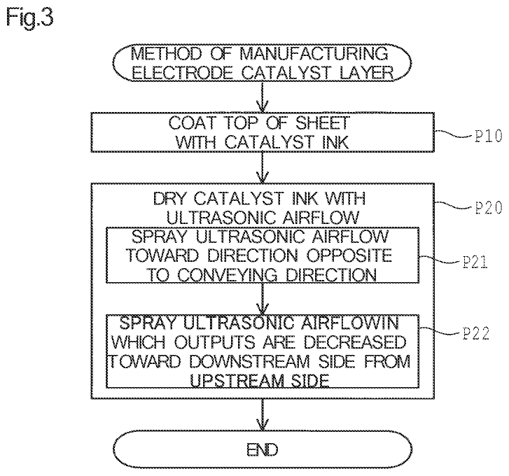

FIG. 3 is a manufacturing process diagram showing the method of manufacturing the electrode catalyst layer 50 in the present embodiment. The top of the base material 96 is coated with a liquid electrode catalyst (hereinafter also referred to as the “catalyst ink”) (step P10). The electrode catalyst is formed of main ingredients which are a catalyst carrying material that carries catalyst particles and the ionomer. As the catalyst carrying material, for example, various types of carbon particles and carbon powders such as carbon black and a carbon nanotube are able to be used. As the catalyst particles, for example, platinum and platinum compounds such as a platinum-cobalt alloy and a platinum-nickel alloy are able to be used. The ionomer is a proton conductive electrolyte material. As the ionomer, for example, a fluorine resin such as Nafion (registered trademark) may be used. For example, the catalyst ink is able to be produced by mixing together catalyst carrying particles mixed in ion-exchange water, a solvent and the ionomer and dispersing the mixture with an ultrasonic homogenizer, a bead mill or the like. As the solvent, for example, diacetone alcohol or the like is able to be used. In the composition of the catalyst ink, its solid content concentration is 9.1%, the weight ratio between the ionomer and the carbon is 0.75 to 0.85, its moisture percentage is 60% and its solvent percentage is 20%. In the particle size distribution of the catalyst ink, D50 is 1 μm or less, and D90 is 3 μm or less. The shear viscosity of the catalyst ink is 35 to 110 mPa·s(562s⁻¹).

In the present embodiment, the catalyst ink is applied with the coater 95 shown in FIG. 2. On a lower end of the coater 95, a die head 93 is provided. The die head 93 is arranged opposite a support roll BR on the downstream side with respect to the feed-out roll 91. The die head 93 applies the catalyst ink stored in the coater 95 on the surface of the base material 96. The catalyst ink is continuously applied with the die head 93 on the surface of the base material 96 which is conveyed to the downstream side so as to be coated in a layer on the base material 96. FIG. 2 shows the catalyst ink Ik with which the top of the base material 96 is coated by use of the coater 95.

The catalyst ink Ik with which the top of the base material 96 is coated in step P10 is dried with an airflow to which ultrasonic waves are applied (hereinafter also referred to as the “ultrasonic airflow”) (step P20). When the ultrasonic airflow is sprayed to the catalyst ink Ik, the solvent on the surface of the catalyst ink Ik is vibrated by ultrasonic vibrations so as to be volatilized, and thus the drying of the catalyst ink Ik proceeds. In the present embodiment, in step P20, the ultrasonic airflow is sprayed to the catalyst ink Ik from a plurality of positions along the conveying direction. Among the positions along the conveying direction, the ultrasonic airflow fed out from the position on the most upstream side is sprayed to the catalyst ink Ik toward a direction opposite to the conveying direction (step P21). The “direction opposite to the conveying direction” means a direction which includes a directional component opposite to the conveying direction.

In the present embodiment, settings are made such that the outputs of the ultrasonic airflow fed out from the positions are decreased toward the most downstream side from the most upstream side along the conveying direction. The outputs of the ultrasonic airflow are able to be adjusted not only by the outputs of ultrasonic waves but also by, for example, the wind pressure or the temperature of the ultrasonic airflow. The outputs of ultrasonic waves are able to be adjusted by, for example, the frequency or the sound pressure level of ultrasonic waves. The frequency of ultrasonic waves is preferably equal to or greater than, for example, 20 kHz, and is more preferably equal to or greater than 50 kHz in terms of the efficiency of drying of the catalyst ink Ik. The sound pressure level of ultrasonic waves is preferably equal to or greater than, for example, 10 dB, and is more preferably equal to or greater than 50 dB in terms of the efficiency of drying of the catalyst ink. The catalyst ink Ik is dried by spraying the ultrasonic airflow in which the outputs thereof are decreased toward the most downstream side from the most upstream side along the conveying direction (step P22). As shown in FIG. 2, the electrode catalyst layer 50 formed by the drying of the catalyst ink Ik is wound on the winding roll 92 together with the base material 96.

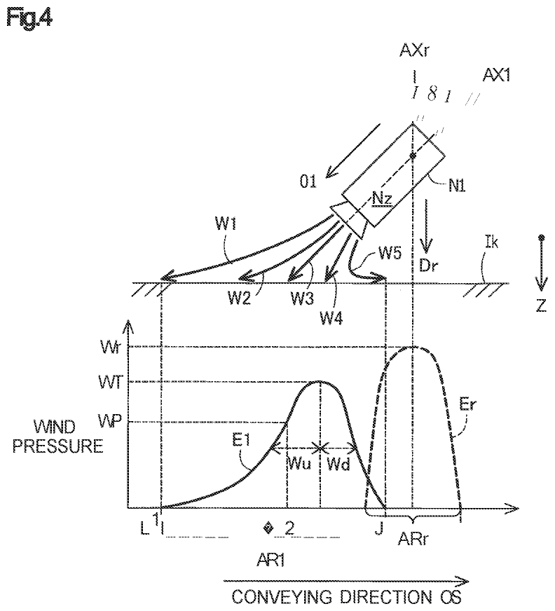

With reference to FIGS. 2 and 4, the details of the ultrasonic dryer 94 which performs step P20 will be described. The ultrasonic dryer 94 is arranged on the downstream side with respect to the coater 95, and sprays the ultrasonic airflow to the catalyst ink Ik on the base material 96 which is conveyed along the conveying direction DS. As shown in FIG. 2, the ultrasonic dryer 94 includes an airflow generation portion 97, a heater 98 and a nozzle portion 99.

The airflow generation portion 97 generates the airflow and supplies it to the heater 98. As the airflow generation portion 97, for example, a compressor such as a blower or an air blower such as a fan is able to be used. The heater 98 warms the airflow supplied from the airflow generation portion 97. In the present embodiment, the airflow (hereinafter also referred to as the “hot air”) warmed with the heater 98 is used for the ultrasonic airflow. By the heating of the hot air, the solvent and moisture in the catalyst ink Ik are evaporated, and thus the drying of the catalyst ink Ik is facilitated. The heating temperature of the heater 98 is preferably set equal to or greater than, for example, 150 degrees so that, the surface temperature of the catalyst ink Ik is equal to or greater than, for example, 100 degrees. The hot air fed out from the heater 98 is supplied to the ultrasonic nozzles Nz of the nozzle portion 99, are passed along flow paths within the ultrasonic nozzles Nz and are fed out from nozzle outlets. The inner pressures of the ultrasonic nozzles Nz are set equal to or greater than, for example, 13 kPa. As will be described later, the heater 98 is able to adjust the temperature of the hot air for each of a plurality of nozzle rows included in the nozzle portion 99.

The nozzle portion 99 includes a plurality of ultrasonic nozzles Nz. The ultrasonic nozzle Nz sprays, to the catalyst ink Ik, the ultrasonic airflow obtained by applying ultrasonic vibrations to the hot air supplied from the heater 98. The ultrasonic nozzle Nz includes an ultrasonic generation portion which generates ultrasonic vibrations. In the present embodiment, the ultrasonic generation portion is the flow path of the airflow within the ultrasonic nozzle Nz, and is the flow path whose width is partially narrowed and which is slit-shaped. The airflow supplied into the ultrasonic nozzle Nz is passed through the slit-shaped flow path so as to cause cavitation and to thereby generate ultrasonic waves. The direction (hereinafter also referred to as the “feed-out direction”) of the ultrasonic airflow fed out from the ultrasonic nozzle Nz coincides with the direction of the ultrasonic nozzle Nz, that is the axial direction of the ultrasonic nozzle Nz. The “feed-out direction of the ultrasonic airflow” means the feed-out direction of the airflow in the center of the ultrasonic airflow fed out from the ultrasonic nozzle Nz. The ultrasonic generation portion may be, for example, an ultrasonic vibrator which is formed with a piezoelectric element such as a piezoelectric ceramic. For example, the vibration surface of the ultrasonic vibrator is configured to serve as the flow path wall of the airflow within the ultrasonic nozzle Nz, and thus ultrasonic vibrations are able to be applied to the airflow which is passed along the flow path within the ultrasonic nozzle Nz.

The output of the ultrasonic airflow is able to be adjusted not only by the output of ultrasonic waves but also by the wind pressure of the airflow of the airflow generation portion 97, the inner pressure (hereinafter also referred to as the “nozzle pressure”) of the ultrasonic nozzle Nz, the heating temperature of the heater 98, the distance between the ultrasonic nozzle Nz and the catalyst ink Ik and the like. In order to reduce the deterioration of the efficiency of application of ultrasonic waves, the distance between the nozzle outlet, of the ultrasonic nozzle Nz and the surface of the catalyst ink Ik is preferably short, and is, for example, preferably equal to or less than 30 mm and is more preferably equal to or less than 10 mm.

In the present embodiment, the nozzle portion 99 includes a plurality of nozzle rows. More specifically, the nozzle portion 99 sequentially includes five nozzle rows from a nozzle row N1 to a nozzle row N5 toward a direction away from the side of the coater 95, that is, toward the downstream side from the upstream side in the conveying direction DS. One nozzle row is formed by arranging a plurality of ultrasonic nozzles Nz along the width direction of the base material 96. The nozzle rows are not limited to the five rows, and any two or more nozzle rows may be provided. The nozzle row may be formed with one ultrasonic nozzle Nz which has a nozzle outlet over the entire width of the base material 96. Among the nozzles, the nozzle which is arranged on the most upstream side in the conveying direction is also referred to as the “upstream side ultrasonic nozzle”, and among the nozzle rows, the nozzle row which is arranged on the most upstream side is also referred to as the “upstream side ultrasonic nozzle row”. Among the nozzles, the nozzle which is arranged on the most downstream side in the conveying direction DS is also referred to as the “downstream side ultrasonic nozzle”, and among the nozzle rows, the nozzle row which is arranged on the most downstream side is also referred to as the “downstream side ultrasonic nozzle row”.

In FIG. 2, the feed-out directions D1 to D5 of the ultrasonic airflow fed out from the individual nozzle rows are shown. In the present embodiment, the feed-out directions D2 to D5 of the nozzle rows N2 to N5 coincide with the Z direction. The nozzle row N1 serving as the upstream side ultrasonic nozzle row is inclined toward the direction opposite to the conveying direction DS, that is, toward the upstream side. The nozzle row N1 sprays the ultrasonic airflow to the catalyst ink Ik on the base material 96 being conveyed from the position on the most upstream side of the nozzle portion 99 toward the direction opposite to the conveying direction DS.

Setting are made such that the outputs of the ultrasonic airflow of the individual nozzle rows are decreased toward the downstream side ultrasonic nozzle row N5 from the nozzle row N1 serving as the upstream side ultrasonic nozzle row. For the output of the ultrasonic airflow of the nozzle row N1, for example, it is possible to make settings such that the distance between the nozzle outlet of the ultrasonic nozzle Nz and the surface of the catalyst ink Ik is 3 mm, that the nozzle pressure is 17 kPa and that the heating temperature of the heater 98 is 250 degrees. For the output of the ultrasonic airflow of the nozzle row N5, for example, it is possible to make settings such that the distance between the nozzle outlet and the surface of the catalyst ink Ik is 20 mm, that the nozzle pressure is 13 kPa and that the heating temperature of the heater 98 is 150 degrees. The outputs of the ultrasonic airflow of the nozzle rows N2 to N4 are outputs between the nozzle row N1 and the nozzle row N5. For the outputs of the ultrasonic airflow of the nozzle rows N2 to N4, for example, it is possible to make settings such that the distance between the nozzle outlet and the surface of the catalyst ink Ik is 10 mm, that the nozzle pressure is 15 kPa and that the heating temperature of the heater 98 is 200 degrees. Although all the outputs of the ultrasonic airflow of the nozzle rows N2 to N4 are set equal to each other in the present embodiment, the output of the nozzle row N2 may be higher than that of the nozzle row N3, and the output of the nozzle row N4 may be lower than that of the nozzle row N3. The outputs of the ultrasonic airflow of the individual nozzle rows may be adjusted by the frequency or the sound pressure level of ultrasonic waves.

FIG. 4 is an illustrative view showing a relationship between the ultrasonic airflow fed out from the upstream side ultrasonic nozzle row N1 and the wind pressure of the ultrasonic airflow applied to the catalyst ink Ik. In the upper side of FIG. 4, a center axis AX1 of the ultrasonic nozzles Nz in the nozzle row N1 and the feed-out direction D1 of the ultrasonic airflow fed out from the nozzle row N1 are shown. The feed-out direction D1 shown in FIG. 4 coincides with the feed-out direction of an airflow W3 in the center of the ultrasonic airflow fed out from the nozzle row N1. In the upper side of FIG. 4, as a reference example, the feed-out direction Dr of the ultrasonic airflow of the nozzle row N1 arranged on a center axis AXr along the Z direction is further shown. The center axis AX1 is inclined only at an angle θ1 with respect to the Z direction and the center axis AXr such that the feed-out direction D1 of the nozzle row N1 is directed to the upstream side. In the present embodiment, the angle θ1 is set to 45 degrees. The angle θ1 is not limited to 45 degrees, and may be set to an angle which is greater than 0 degrees and less than 90 degrees. The angle θ1 is preferably set greater than 20 degrees and less than 70 degrees in order to reduce the deterioration of the efficiency of application of ultrasonic waves, and is more preferably set greater than 30 degrees and less than 60 degrees in order to efficiently dry the catalyst ink Ik.

The ultrasonic airflow fed out from the ultrasonic nozzle Nz is dispersed by air resistance and contact with the catalyst ink. In the upper side of FIG. 4, for ease of understanding of the technology, the flow directions of the ultrasonic airflow fed out from the nozzle row N1 along the feed-out direction D1 are schematically shown as airflows W1 to W5.

In the lower side of FIG. 4, the distribution of the wind pressure of the ultrasonic airflow is schematically shown. The horizontal axis represents positions along the conveying direction DS, and the vertical axis represents the magnitude of the wind pressure. The horizontal axis corresponds to the horizontal axis in the upper side of FIG. 4. In the lower side of FIG. 4, the distribution E1 of the wind pressure of the ultrasonic airflow fed out from the nozzle row N1 toward the feed-out direction D1 is indicated by a solid line, and as a reference example, the distribution Er of the wind pressure of the ultrasonic airflow fed out along the feed-out direction Dr is indicated by a broken line. The output of the ultrasonic airflow fed out along the feed-out direction D1 and the output of the ultrasonic airflow fed out toward the feed-out direction Dr are equal to each other.

In the lower side of FIG. 4, a range AR1 in which the wind pressure is applied to the catalyst ink Ik in the distribution E1 and a range ARr in which the wind pressure is applied to the catalyst ink Ik in the distribution Er are shown. In the present embodiment, the nozzle row N1 is inclined toward the upstream side, and thus the range AR1 is shifted to the upstream side as compared with the range ARr so as to be a wider range, than the range ARr. The maximum value WT of the wind pressure in the distribution E1 is lower than the maximum value Wr of the wind pressure in the distribution Er. The spread of the wind pressure at the half of the maximum value WT in the distribution E1 (hereinafter also referred to as the “half width”) is larger on the upstream side. More specifically, a half width Wu on the upstream side in the distribution E1 is larger than a half width Wd on the downstream side. The half width Wu is preferably 1.5 times as large as the half width Wd in order to efficiently dry the catalyst ink Ik on the upstream side.

In FIG. 4, a wind pressure W1 in a position L2 is indicated. When an ultrasonic airflow which has the wind pressure WP or greater is sprayed to the catalyst ink Ik, the catalyst ink Ik after the coating is sprayed out, and thus a failure may occur in which the catalyst ink Ik exceeds the dimensions of a predetermined coating range on the base material 96. While the catalyst ink Ik is conveyed from a position L1 on the most upstream side reached by the ultrasonic airflow to the position L2, the wind pressure of the ultrasonic airflow fed out from the nozzle row N1 is maintained to be less than the wind pressure WP. Hence, the drying of the catalyst ink Ik is able to proceed while the spraying out of the catalyst ink Ik on the surface of the layer is being reduced. In the catalyst ink Ik which reaches the position L2, the drying proceeds such that the catalyst ink Ik is prevented from being sprayed out on the surface of the layer. The position L2 may be adjusted to be on the upstream side or on the downstream side by the adjustment of the output of the ultrasonic airflow or the angle θ1 of the nozzle row N1.

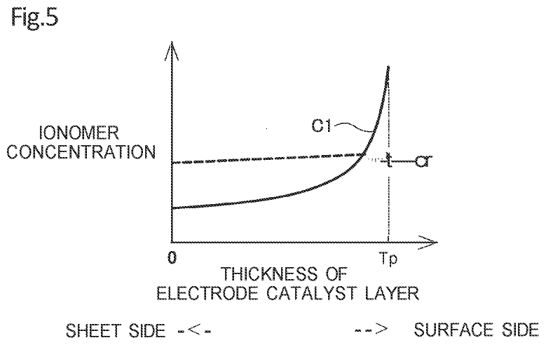

FIG. 5 is a graph showing the distribution of concentration of the ionomer in the direction of thickness of the electrode catalyst layer 50 which is manufactured by the method of manufacturing the fuel cell catalyst layer in the present embodiment. The horizontal axis represents the thickness of the electrode catalyst layer 50, and the vertical axis represents the magnitude of concentration of the ionomer. In the graph of FIG. 5, a distribution C1 which is an example of the distribution of concentration of the ionomer and a distribution Cr which serves as a reference example are shown. The distribution C1 indicates the distribution of concentration of the ionomer in the electrode catalyst layer 50 manufactured with the catalyst layer manufacturing apparatus 90 which includes the nozzle portion 99 described above. The distribution Cr indicates the distribution of concentration of the ionomer in the electrode catalyst layer 50 manufactured with the catalyst layer manufacturing apparatus 90 in which the outputs of the ultrasonic airflow of the individual nozzle rows are set equal to each other.

As shown in FIG. 5, in the distribution C1, the concentration of the ionomer on the surface side of the electrode catalyst layer 50 is higher than in the distribution Cr. In the present embodiment, in the individual nozzle rows, settings are made such that the outputs of the ultrasonic airflow are decreased toward the downstream side ultrasonic nozzle row N5 from the upstream side ultrasonic nozzle row N1. The output of the ultrasonic airflow on the upstream side is set higher than on the downstream side, and thus the speed of reduction of the solvent within the catalyst ink Ik by the drying is higher than the speed of diffusion of the ionomer within the catalyst ink Ik. Hence, as indicated as the distribution C1 of FIG. 5, the electrode catalyst layer 50 in a state where the ionomer is unevenly distributed to the surface side of the catalyst ink Ik as compared with the distribution Cr is formed.

As described above, in the method of manufacturing the electrode catalyst layer 50 in the present embodiment, the ultrasonic airflow in which the center is directed in the direction opposite to the conveying direction DS is sprayed to the catalyst ink Ik being conveyed along the conveying direction DS, and thus the catalyst ink Ik is dried. It is possible to spray the ultrasonic airflow from the nozzle row N1 toward the catalyst ink Ik in a wide range on the upstream side. Hence, it is possible to spray, toward the catalyst ink Ik on the upstream side, the ultrasonic airflow which has such a low wind pressure that the catalyst ink Ik is prevented from being sprayed out on the surface of the layer, with the result that it is possible to facilitate the drying of the catalyst ink Ik on the upstream side. Thus, it is possible to reduce a failure in which the catalyst ink Ik after the coating is sprayed out by the ultrasonic airflow thereby exceeding the coating range on the predetermined base material 96.

In the method of manufacturing the electrode catalyst layer 50 in the present embodiment, the ultrasonic airflow is fed out from a plurality of positions along the conveying direction DS. The ultrasonic airflow fed out from the most upstream side among the positions is sprayed to the catalyst ink Ik toward the direction opposite to the conveying direction DS. It is possible to enhance the outputs of the entire ultrasonic airflow while reducing a failure in which the catalyst ink Ik exceeds the coating range on the predetermined base material 96.

In the method of manufacturing the electrode catalyst layer 50 in the present embodiment, settings are made such that the outputs of the ultrasonic airflow are decreased toward the downstream side from the upstream side in the conveying direction DS. Hence, it is possible to unevenly distribute the ionomer to the surface side of the electrode catalyst layer 50. Thus, it is possible to reduce the resistance of the electrode catalyst layer 50 and to thereby enhance the catalytic performance of the electrode catalyst layer 50. The membrane electrode assembly 20 is formed in which the electrode catalyst layer 50 is arranged such that the surface side where the ionomer is unevenly distributed and the electrolyte membrane 21 are brought into contact with each other, and thus it is possible to reduce impedance between the electrolyte membrane 21 and the electrode catalyst layer 50, with the result that it is possible to enhance the high-temperature power generation performance and the sub-zero starting durability of the fuel cell 200.

In the ultrasonic dryer 94 of the present embodiment, it is possible to spray, with the nozzle row N1, the ultrasonic airflow to the wide range of the catalyst ink Ik. With the nozzle row N1, it is possible to spray, toward the catalyst ink Ik on the upstream side, the ultrasonic airflow which has such a low wind pressure that the catalyst ink Ik is prevented from being sprayed out on the surface of the layer. Hence, it is possible to facilitate the drying of the catalyst ink Ik on the upstream side without separately providing an ultrasonic nozzle Nz for feeding out an ultrasonic airflow having a low wind pressure, with the result that it is possible to reduce the size of the ultrasonic dryer 94.

### B. Other Embodiments

(B1) Although in the embodiment described above, the nozzle portion 99 includes a plurality of ultrasonic nozzles Nz, the nozzle portion 99 may include one ultrasonic nozzle Nz which sprays the ultrasonic airflow toward the side opposite to the conveying direction DS. In this case, the ultrasonic nozzle Nz preferably includes a nozzle outlet over the entire width of the base material 96.

(B2) Although in the embodiment described above, the example is described where the heater 98 and the airflow generation portion 97 are provided separately from the ultrasonic nozzles Nz, the heater 98 and the airflow generation portion 97 may be provided within the ultrasonic nozzles Nz. The heater 98 and the airflow generation portion 97 may be provided in each of the ultrasonic nozzles Nz or may be provided in an arbitrary number of ultrasonic nozzles Nz among the ultrasonic nozzles Nz. The heater 98 and the airflow generation portion 97 may be provided in each of a plurality of nozzle rows or may be provided in an arbitrary nozzle row among the nozzle rows.

(B3) In the embodiment described above, the example is described where the feed-out direction of the ultrasonic airflow coincides with the direction of the ultrasonic nozzle Nz. On the other hand, the feed-out direction of the ultrasonic airflow does not need to coincide with the direction of the ultrasonic nozzle Nz or may be a direction intersecting the axial direction of the ultrasonic nozzle Nz. The ultrasonic nozzle Nz may include a plurality of nozzle outlets so as to have a plurality of feed-out directions of the ultrasonic airflow.

(B4) Although in the embodiment described above, in the nozzle portion 99, settings are made such that the outputs of the ultrasonic airflow are decreased toward the most downstream side nozzle row N5 in the conveying direction DS from the upstream side ultrasonic nozzle row N1, all the outputs of the ultrasonic airflow of the individual nozzle rows in the nozzle portion 99 may be set equal to each other.

The present disclosure is not limited to any of the embodiment and the other embodiments described above but may be implemented by various other configurations without departing from the scope of the disclosure. For example, the technical features of any of the above embodiment and the other embodiments may be replaced or combined appropriately, in order to solve part or all of the problems described above or in order to achieve part or all of the advantageous effects described above. Any of the technical features may be omitted appropriately unless the technical feature is described as essential herein. The present disclosure may be implemented by aspects described below.

(1) According to one aspect of the present disclosure, a method of manufacturing a fuel cell catalyst layer is provided. The method of manufacturing a fuel cell catalyst layer includes: coating a top surface of a sheet with a catalyst ink, wherein the catalyst ink includes an ionomer; and drying the catalyst ink on the sheet being conveyed along a conveying direction by spraying a center of an ultrasonic airflow toward a direction opposite to the conveying direction, wherein the ultrasonic airflow is obtained by applying ultrasonic waves to an airflow. In the method of manufacturing a fuel cell catalyst layer according to this aspect, the ultrasonic airflow in which the center is directed in the direction opposite to the conveying direction is sprayed to the catalyst ink being conveyed along the conveying direction, and thus the catalyst ink is dried. It is possible to spray the ultrasonic airflow from one position toward the catalyst ink in a wide range on the upstream side. Hence, it is possible to spray, toward the catalyst ink on the upstream side, the ultrasonic airflow which has such a low wind pressure that the catalyst ink is prevented from being sprayed out on the surface of the layer, with the result that it is possible to facilitate the drying of the catalyst ink on the upstream side. Thus, it is possible to reduce a failure in which the catalyst ink after the coating is sprayed out by the ultrasonic airflow, thereby exceeding a coating range on the sheet.

(2) In the method of manufacturing a fuel cell catalyst layer according to the aspect described above, the ultrasonic airflow may be fed out from a plurality of positions along the conveying direction, and the ultrasonic airflow fed out from a most upstream side position in the conveying direction among the positions may be sprayed toward the opposite direction. In the method of manufacturing a fuel cell catalyst layer according to this aspect, the ultrasonic airflow is fed out from a plurality of positions along the conveying direction. The ultrasonic airflow fed out from the most upstream side among the positions is sprayed to the catalyst ink toward the direction opposite to the conveying direction. It is possible to enhance the outputs of the entire ultrasonic airflow while reducing a failure in which the catalyst ink exceeds the coating range on the predetermined base material.

(3) In the method of manufacturing a fuel cell catalyst layer according to the aspect described above, outputs of the ultrasonic airflow fed out from the positions may be decreased toward a most downstream side in the conveying direction from the most upstream side. In the method of manufacturing a fuel cell catalyst layer according to this aspect, it is possible to unevenly distribute the ionomer to the surface side of the electrode catalyst layer. Thus, it is possible to reduce the resistance of the electrode catalyst layer and to thereby enhance the catalytic performance of the electrode catalyst layer. The electrode catalyst layer is arranged such that the surface side where the ionomer is unevenly distributed and the electrolyte membrane are brought into contact with each other, and thus it is possible to reduce impedance between the electrolyte membrane and the electrode catalyst layer, with the result that it is possible to enhance the high-temperature power generation performance and the sub-zero starting durability of the fuel cell.

The present disclosure is able to be realized in various aspects other than the method of manufacturing a fuel cell catalyst layer. For example, the present disclosure is able to be realized in aspects such as a method of manufacturing a membrane electrode assembly including a catalyst layer, a method of manufacturing a fuel cell including a catalyst layer, a dryer which is used in the manufacturing of a fuel cell catalyst layer, a method of controlling a dryer, a computer program which realizes the controlling method described above and a recording medium which records the computer program described above and which is non-transitory.

What is claimed is:

1. A method of manufacturing a fuel cell catalyst layer, the method comprising:
coating a top surface of a sheet with a catalyst ink, wherein the catalyst ink includes an ionomer; and
drying the catalyst ink on the sheet being conveyed along a conveying direction by spraying a center of an ultrasonic airflow toward a direction opposite to the conveying direction, wherein the ultrasonic airflow is obtained by applying ultrasonic waves to an airflow.

2. The method of manufacturing a fuel cell catalyst layer according to claim 1,
wherein the ultrasonic airflow is fed out from a plurality of positions along the conveying direction, and
the ultrasonic airflow fed out from a most upstream side position in the conveying direction among the positions is sprayed toward the opposite direction.

3. The method of manufacturing a fuel cell catalyst layer according to claim 2,
wherein outputs of the ultrasonic airflow fed out from the positions are decreased toward a most downstream side in the conveying direction from the most upstream side.

4. A dryer used in manufacturing of a fuel cell catalyst layer, the dryer comprising:
an airflow generator configured to generate an airflow;
an ultrasonic generator configured to generate ultrasonic waves; and
an ultrasonic nozzle configure to spray a center of an ultrasonic airflow toward a direction opposite to a conveying direction, wherein a catalyst ink on the sheet is conveyed along the conveying direction, wherein the catalyst ink includes an ionomer and coated in a top surface of the sheet, wherein the ultrasonic airflow is obtained by applying the ultrasonic waves to the airflow.
